(19) United States
(12) Patent Application Publication
(10) Pub. No.: US 2021/0292250 A1
(43) Pub. Date: Sep. 23, 2021

(54) METAL-ORGANIC FRAMEWORK MATERIAL FERTILIZER AND PREPARATION METHOD THEREFOR

(71) Applicant: NANJING INSTITUTE OF SOIL CHINESE ACADEMY OF SCIENCES, Gulou Nanjing (CN)

(72) Inventors: Changwen DU, Gulou Nanjing (CN); Ke WU, Gulou Nanjing (CN)

(21) Appl. No.: 17/257,349

(22) PCT Filed: Dec. 4, 2018
(86) PCT No.: PCT/CN2018/119130

§ 371 Date: Dec. 31, 2020

(30) Foreign Application Priority Data
Jul. 4, 2018 (CN) 201810724689.0

(51) Int. Cl. C05B 15/00; C05D 9/02; C05G 1/00

(52) U.S. Cl. CPC C05B 15/00; C05G 1/00; C05D 9/02

(57) ABSTRACT

A metal-organic framework material fertilizer and a preparation method therefor is provided. The novel fertilizer consists of nutrient molecules and external frameworks thereof, and is characterized in that the external frameworks are formed by coordination of inorganic metal ion clusters to organic joints under hydrothermal conditions. The metal-organic framework materials include two types, i.e., zinc-free and zinc-containing. The hydrothermal synthesis conditions of the novel metal-organic framework material fertilizer are that: the reaction temperature is 100° C., the reaction time is 24 h, the heating rate of the reactor is 2° C./min, and the speed of the stir bar is 120 revolutions per minute. The nutrient contents of the novel fertilizer are as follows: compound I: N: 4-5%, and P: 16-20%; and compound II: N: 5-7%, P: 15-18%, and Zn: 2-3%.

### CROSS-REFERENCE TO RELATED APPLICATIONS

This application claims priority to PCT Application No. PCT/CN2018/119130 having a filing date of Dec. 4, 2018, which is based on CN Application No. 201810724689.0, having a filing date of Jul. 4, 2018, the entire contents both of which are hereby incorporated by reference.

### FIELD OF TECHNOLOGY

The following pertains to the field of fertilizer manufacturing technology and specifically designs a new type of metal-organic framework material fertilizer and a preparation method therefor.

### BACKGROUND

As we all know, chemical fertilizers play an important role in agricultural production. According to the statistical data from the Food and Agriculture Organization of the United Nations (FAO), fertilizers contribute to 40-60% of the increase of food production^{[1]}. The global population is about 7 billion at present and is expected to reach 9.5 billion by 2050^{[2]}. By then, the demand for food will be twice the present. It is foreseeable that chemical fertilizers will become more outstanding in the next few decades and the consumption of chemical fertilizers will also increase significantly^{[3]}. However, the problem of unreasonable fertilization is still prominent, resulting in a low fertilizer utilization rate, which in turn leads to many environmental problems and huge waste of resources. As one of the important ways to improve the utilization rate of chemical fertilizers, the technical upgrading of existing chemical fertilizers and the development of new fertilizers have received extensive attention at home and abroad^{[4]}.

Metal-organic framework material is also called a metal-organic coordination polymer, wherein organic bridging ligands connect inorganic metal centers (metal ions or metal ion clusters) by coordination bonds to form a crystalline material with an infinitely extending network structure. According to the extension condition of a metal-organic framework material in the spatial dimension, the metal-organic frame material can be divided into one-dimensional chains, two-dimensional layers and a three-dimensional spatial network structure. The biggest feature of a metal-organic frame material is that it is a crystalline material with ultra-high porosity and a huge internal specific surface area. Moreover, the structures made of different inorganic metal ions and organic joints are diverse and adjustable, which provide metal-organic framework materials with a wide range of applications in many aspects, such as gas storage^{[5-7]}, catalysis^{[8]} and a new generation of batteries and medical carriers^{[9, 10]}.

In order to obtain more stable target products with a larger pore size and specific surface area, structure directing agents are often used. Originally, the original structure directing agents were inorganic metal cations^{[11]}. Compared with inorganic structure directing agents, organic structure directing agents can significantly increase framework stability^{[12]}. Therefore, organic templates have become a choice for structure directing agents. Considering their features, especially their size, shape and protonation ability, amines, especially diamines, diaminopropane and piperazine, have become potential choices for structure directing agents^{[13-16]}. For most metal-organic framework materials synthesized using amines as structure directing agents, the amines are generally used as guests and are located in the channels and pores of the frameworks through Van der Waals forces or hydrogen bonding^{[15]}. Under normal condition, the structure of a structure directing agent remains unchanged, and in some cases, the structure directing agent may also be completely or partially decomposed into more stable secondary structures^{[16]}.

Although metal-organic framework materials have been used in many fields, they are rarely reported as fertilizers. As fertilizers, metal-organic framework materials should contain nutrients essential to crops, such as nitrogen and phosphorus and metal nutrients that may be essential, such as magnesium, iron, zinc and boron. Considering that diamines are usually used as structure directing agents and can provide nitrogen, urea (a popular conventional nitrogen fertilizer compound) as the simplest diamine is used as a structure directing agent in embodiments of the present invention to synthesize a metal-organic framework material.

### REFERENCES

[1] W. M. Stewart, D. W. Dibb, A. E. Johnston, T. J. Smyth, The contribution of commercial fertilizer nutrients to food production[J]. Agron J., 97 (2005) 1-6.
[2] P. W. Gerbens-Leenes, S. Nonhebel, W. P. M. F. Ivens, A method to determine land requirements relating to food consumption patterns [J]. Agric. Ecosyst Environ., 90 (2002) 47-58.
[3] M. E. Brown, B. Hintermann, N. Higgins, Markets, climate change, and food security in West Africa[J]. Environ. Sci. Technol., 2009, 43 (21): 8016-8020.
[4] XIA, Xunfeng and HU, Hong. Current use status of fertilizers and development of new types of fertilizers in China [J]. Technology and Development of Chemical Industry, 40 (2011) 45-48.
[5] M. Eddaoudi, H. Li, O. M. Yaghi, Highly Porous and Stable Metal-Organic Frameworks: Structure Design and Sorption Properties, J. Am. Chem. Soc. 122 (2000) 1391-1397.
[6] S. Kitagawa, R. Kitaura, S. Noro, Functional porous coordination polymers, Angew. Chem. Int. Ed. Engl. 43 (2004) 2334-2375.
[7] L. J. Murray, M. Dined, J. R. Long, Hydrogen storage in metal-organic frameworks. Chem. Soc. Rev. 38 (2009) 1294-1314.
[8] D. Farrusseng, S. Aguado, C. Pinel, Metal-organic frameworks: opportunities for catalysis, Angew. Chem. Int. Ed. Engl. 48 (2009) 7502-7513.
[9] C. Janiak, Engineering coordination polymers towards applications, Dalton Transactions, 14 (2003) 2781-2804.
[10] U. Mueller, M. Schubert, F. Teich, H. Puetter, K. Schierle-Amdt, J. Pastre, Metal-organic frameworks—prospective industrial applications. J. Mater. Chem. 16 (2006) 626-636.
[11] K. H. Lii, Y. F. Huang, V. Zima, C. Y. Huang, H. M, Lin, Y. C. Jiang, F. L. Liao, S. L. Wang, Syntheses and Structures of Organically Templated Iron Phosphates. Chem. Mater. 10 (1998) 2599-2609.
[12] A. K. Cheetham, G. Ferey, T. Loiseau, Open-framework inorganic materials. Angew. Chem. Int. Ed. 38 (1999) 3268-3292.
[13] S. Nataraj an, S. Mandal, P. Mahata, K. V Ramya, The use of hydrothermal methods in the synthesis of novel open framework materials. J. Chem. Sci. 118 (2006) 525-536.
[14] T. Huang, B. A. Vanchura, Y. Shan, S. D. Huang, Na (H3-NCH2CH2NH3) 0.5[Co(C2O4)(HPO4)]: a novel phosphoxalate open-firamework compound incorporating
both an alkali cation and an organic template in the structural tunnels, J. Solid. State. Chem. 180 (2007) 2110-2115.
[15] P. M. Forster, A. K. Cheetham, Hybrid Inorganic-Organic Solids: An Emerging Class of Nanoporous Catalysts, Top. Catal. 24 (2003) 79-86.
[16] N. Rajic, D. Stojakovic, D. Hanzel, V. Kaucic, The structure directing role of 1,3-diaminopropane in the hydrothermal synthesis of iron (III) phosphate. J. Serb. Chem. Soc. 69 (2004) 179-185.

### SUMMARY

An aspect relates to a metal-organic framework material fertilizer. The following further relates to a preparation method for the metal-organic framework material fertilizer. The following adopts a relatively mild hydrothermal synthesis method, uses urea as a structure directing agent, trivalent iron ions, divalent zinc ions and orthophosphoric acid as an inorganic part and oxalic acid as an organic joint to synthesize a metal-organic framework material and then determines nutrient content of the metal-organic framework material. The results show that the material has a high nutrient content. Finally, the release of the material is measured through soil cultivation. The experimental results show that the nutrient release cycle of the metal-organic framework material can be more than 4 months.

The technical solution for completing the above-mentioned first embodiment of the invention task is: a metal-organic framework material fertilizer, comprising nutrient molecules and external frameworks thereof and characterized in that the external frameworks are formed by coordination of inorganic metal ion clusters to organic joints.

The nutrient molecules may be selected from various amine fertilizer molecules.

The molar ratio composition of the components of the metal-organic framework material includes:

| | |
|---|---|
| Ferric chloride (FeCl₃•6H₂O) | 0.25-2, |
| Phosphoric acid (H₃PO₄) | 5-8, |
| Oxalic acid (H₂C₂O₄•2H₂O) | 0.5-1.5, |
| Urea (CO(NH₂)₂) | 3-5, |
| Deionized water (H₂O) | 100. |

In the molar ratio composition of the components of the metal-organic framework material, zinc sulfate (ZnSO₄.7H₂O) 0.1-0.5 mol can be added.

In other words, the metal-organic framework materials comprise two types, i.e., zinc-free and zinc-containing.

Among them, the molar ratio of the raw materials of a zinc-free metal-organic framework material (compound I) is:

| | |
|---|---|
| Ferric chloride (FeCl₃•6H₂O) | 0.25-2, |
| Phosphoric acid (H₃PO₄) | 5-8, |
| Oxalic acid (H₂C₂O₄•2H₂O) | 0.5-1.5, |
| Urea (CO(NH₂)₂) | 3-5, |
| Deionized water (H₂O) | 100. |

The molar ratio of the raw materials of a zinc-containing metal-organic framework material (compound II) is:

| | |
|---|---|
| Ferric chloride (FeCl₃•6H₂O) | 0.25-2, |
| Zinc sulfate (znso₄•7H₂O) | 0.1-0.5, |
| Phosphoric acid (H₃PO₄) | 5-8, |
| Oxalic acid (H₂C₂O₄•2H₂O) | 0.5-1.5, |
| Urea (CO(NH₂)₂) | 1-5, |
| Deionized water (H₂O) | 100. |

The optimum formula and optimum synthesis parameters of a metal-organic framework material fertilizer synthesized through hydrothermal reaction in embodiments of the present invention are:

| Compound I: | |
|---|---|
| Ferric chloride | 0.5-1.5, |
| Phosphoric acid | 4-8, |
| Oxalic acid | 1-2, |
| Urea (CO(NH₂)₂) | 3-5, |
| Deionized water (H₂O) | 100. |
| Compound II: | |
| Ferric chloride | 1-2, |
| Zinc sulfate | 0.25-0.30, |
| Phosphoric acid | 4-5, |
| Oxalic acid | 1-2, |
| Urea (CO(NH₂)₂) | 5-8, |
| Deionized water (H₂O) | 100. |

The reaction temperature is 100° C., the reaction time is 24 h and the heating rate of the reactor is 2° C./min.

The technical solution for completing the above-mentioned second embodiment of the invention task is: preparation of a metal-organic framework material fertilizer. The method is as follows:

Compound I:

(1). Completely dissolve ferric chloride, phosphoric acid, oxalic acid and urea in deionized water and mix them well to form a mixed solution.

(2). Pour the mixed solution into a stainless steel reactor and then completely seal the reactor. Set the reaction temperature at 100° C., the reaction time at 24 h and the reactor heating rate at 2° C./min.

(3). Open the reactor when the temperature drops to room temperature after the reaction is over, filter the solution with filter paper and then wash with deionized water 3 times to obtain a product.

Compound II:

(1). Completely dissolve ferric chloride, zinc sulfate, phosphoric acid, oxalic acid and urea in deionized water and mix them well to form a mixed solution.

(2). Pour the mixed solution into a stainless steel reactor and then completely seal the reactor. Set the reaction temperature at 100° C., the reaction time at 24 h and the reactor heating rate at 2° C./min.

(3). Open the reactor when the temperature drops to room temperature after the reaction is over, filter the solution with filter paper and then wash with deionized water 3 times to obtain a product.

Embodiments of the present invention are to synthesize a metal-organic framework material as a fertilizer from a microscopic level using metal ions and phosphoric acid as an inorganic part, oxalic acid as an organic joint and urea as a structure directing agent under mild hydrothermal reaction conditions. The fertilizer contains nutrients N, P and Zn essential to crops. The nutrient contents are as follows: compound I: N, 4-5%, P, 16-20%; compound II: N, 5-7%, P, 15-18%, Zn-2-3%. The soil cultivation test shows that the metal-organic framework material fertilizer produced according to embodiments of the present invention releases nutrients stably in a long cycle, the 16-week cumulative release rate of N nutrient element is more than 35% and that of P is about 10% and the metal-organic framework material fertilizer has a desirable release control effect and is environmentally friendly.

### BRIEF DESCRIPTION

Some of the embodiments will be described in detail, with references to the following Figures, wherein like designations denote like members, wherein:

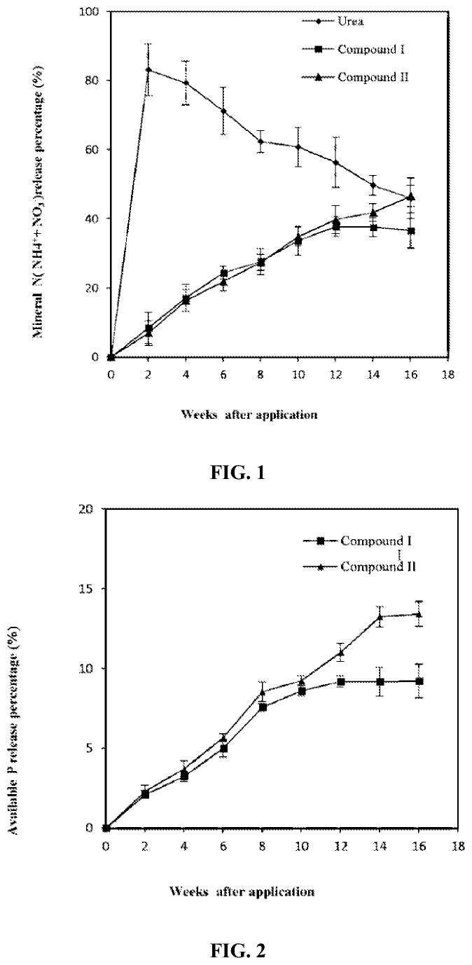

FIG. 1 depicts a curve of the release percentage (%) of available nitrogen (ammonium nitrogen and nitrate nitrogen);

FIG. 2 depicts a curve of the release percentage (%) of available phosphorus; and

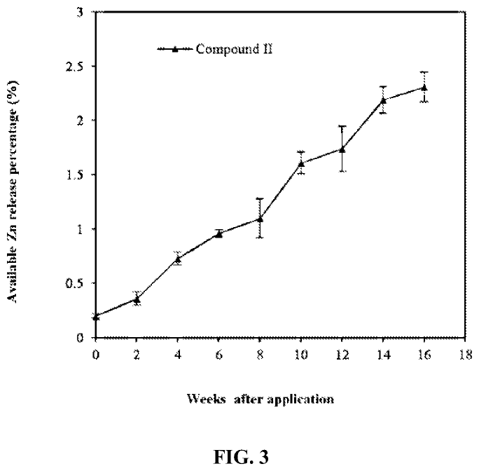

FIG. 3 depicts a curve of the release percentage (%) of available zinc.

### DETAILED DESCRIPTION

Embodiment 1, a metal-organic framework material fertilizer and a preparation method therefor, preparation of compound I: Weigh 1 mol of ferric chloride, 6 mol of phosphoric acid, 1 mol of oxalic acid, 3 mol of urea (CO(NH₂)₂) and 100 mol of deionized water (H₂O), put them in a beaker, stir them with a glass rod, pour them into a reactor after the oligomers are completely dissolved and mixed well, completely seal the reactor, set the reaction temperature at 100° C., the reaction time at 24 h, the reactor heating rate at 2° C./min and the speed of the stir bar at 120 rpm, open the reactor when the temperature drops to room temperature after the reaction is over, filter the solution with filter paper and then wash with deionized water 3 times to obtain a product.

Nutrient release determination method: Accurately weigh 0.13 g of urea, mix it with 300 g of the test soil, and then add them to a culture plate with a diameter of 15 cm. Weigh the samples with the same nitrogen content according to the nitrogen contents of compound I and compound II, mix each of them with 300 g of the test soil, and add the mixtures to plates and then adjust the water content of each culture plate to 38%. Cover the culture plates with plastic wraps to prevent the water from evaporating too quickly, repeat each treatment 3 times and place all the plates in a cool place in the laboratory. Take soil samples once every two weeks. Use a discrete automatic analyzer (SmartChem200, Alliance, France) to determine the content of available nitrogen (ammonium nitrogen and nitrate nitrogen) and use ICAP-OES (ICAP 7000, Thermo Fisher, UK) to determine the contents of available phosphorus and available zinc.

Embodiment 2, a metal-organic framework material fertilizer and a preparation method therefor, preparation of compound II: Weigh 1 mol of ferric chloride, 0.25 mol of zinc sulfate, 6 mol of phosphoric acid, 1 mol of oxalic acid, 3 mol of urea (CO(NH₂)₂) and 100 mol of deionized water (H₂O), put them in a beaker, stir them with a glass rod, pour them into a reactor after the oligomers are completely dissolved and mixed well, completely seal the reactor, set the reaction temperature at 100° C., the reaction time at 24 h, the reactor heating rate at 2° C./min and the speed of the stir bar at 120 rpm, open the reactor when the temperature drops to room temperature after the reaction is over, filter the solution with filter paper and then wash with deionized water 3 times to obtain a product.

Embodiment 3, basically the same as Embodiment 1, except the following changes: The molar ratio of the raw materials of the metal-organic framework material is as follows: Ferric chloride (FeCl₃.6H₂O) 0.25, phosphoric acid (H₃PO₄) 5, oxalic acid (H₂C₂O₄.2H₂O) 0.5, urea (CO(NH₂)₂) 3, and deionized water (H₂O) 100.

Embodiment 4, basically the same as Embodiment 1, except the following changes: The molar ratio of the raw materials of the metal-organic framework material is as follows: Ferric chloride (FeCl₃.6H₂O) 2, phosphoric acid (H₃PO₄) 8, oxalic acid (H₂C₂O₄.2H₂O) 1.5, urea (CO(NH₂)₂) 5, and deionized water (H₂O) 100.

Embodiment 5, basically the same as Embodiment 1, except the following changes: The molar ratio of the raw materials of the metal-organic framework material is as follows: Ferric chloride (FeCl₃.6H₂O) 0.25, phosphoric acid (H₃PO₄) 8, oxalic acid (H₂C₂O₄.2H₂O) 0.5, urea (CO(NH₂)₂) 5, and deionized water (H₂O) 100.

Embodiment 6, basically the same as Embodiment 1, except the following changes: The molar ratio of the raw materials of the metal-organic framework material is as follows: Ferric chloride (FeCl₃.6H₂O) 2, phosphoric acid (H₃PO₄) 5, oxalic acid (H₂C₂O₄.2H₂O) 1.5, urea (CO(NH₂)₂) 3, and deionized water (H₂O) 100.

Embodiment 7, basically the same as Embodiment 1, except the following changes: The molar ratio of the raw materials of the metal-organic framework material is as follows: Ferric chloride (FeCl₃ 6H₂O) 0.25, zinc sulfate (ZnSO₄.7H₂O) 0.1, phosphoric acid (H₃PO₄) 5, oxalic acid (H₂C₂O₄.2H₂O) 0.5, urea (CO(NH₂)₂) 1, and deionized water (H₂O) 100.

Embodiment 8, basically the same as Embodiment 2, except the following changes: The molar ratio of the raw materials of the zinc-containing metal-organic framework material (compound II) is as follows: Ferric chloride (FeCl₃.6H₂O) 2, zinc sulfate (ZnSO₄.7H₂O) 0.5, phosphoric acid (H₃PO₄) 8, oxalic acid (H₂C₂O₄.2H₂O) 1.5, urea (CO(NH₂)₂) 5, and deionized water (H₂O) 100.

Embodiment 9, basically the same as Embodiment 2, except the following changes: The molar ratio of the raw materials of the zinc-containing metal-organic framework material is as follows: Ferric chloride (FeCl₃.6H₂O) 0.25, zinc sulfate (ZnSO₄.7H₂O) 0.5, phosphoric acid (H₃PO₄) 5, oxalic acid (H₂C₂O₄.2H₂O) 1.5, urea (CO(NH₂)₂) 1, and deionized water (H₂O) 100.

Embodiment 10, basically the same as Embodiment 2, except the following changes: The molar ratio of the raw materials of the zinc-containing metal-organic framework material is as follows: Ferric chloride (FeCl₃.6H₂O) 2, zinc sulfate (ZnSO₄.7H₂O) 0.1, phosphoric acid (H₃PO₄) 8, oxalic acid (H₂C₂O₄.2H₂O) 0.5, urea (CO(NH₂)₂) 5, and deionized water (H₂O) 100.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A metal-organic framework material fertilizer, comprising:
nutrient molecules; and
external frameworks thereof, wherein the external frameworks are formed by coordination of inorganic metal ion clusters to organic joints under hydrothermal conditions.

2. The new type of metal-organic framework material fertilizer according to claim 1, wherein the molar ratio composition of the raw materials of the synthesized metal-organic framework material includes:

| | |
|---|---|
| ferric chloride | 0.25-2, |
| phosphoric acid | 5-8, |
| oxalic acid | 0.5-15, |
| urea | 3-5, |
| deionized water | 100. |

3. The metal-organic framework material fertilizer according to claim 2, wherein in the molar ratio composition of the components of the metal-organic framework material, zinc sulfate 0.1-0.5 mol is added.

4. The metal-organic framework material fertilizer according to claim 2, wherein the molar ratio of a formula of the synthesized organic framework material fertilizer is as follows: ferric chloride 1, phosphoric acid 6, oxalic acid 1, urea 3, and deionized water 100.

5. The metal-organic framework material fertilizer according to claim 3, wherein the molar ratio of a formula of the synthesized organic framework material fertilizer is as follows: ferric chloride 1, zinc sulfate 0.25, phosphoric acid 6, oxalic acid 1, urea 3, and deionized water 100.

6. The metal-organic framework material fertilizer according to claim 1, wherein the hydrothermal synthesis parameters include: reaction temperature 100° C., reaction time 24 h, reactor heating rate 2° C./min, and stir bar speed 120 rpm.

7. Preparation of the metal-organic framework material fertilizer according to claim 2, wherein there are the following steps,
a. completely dissolve ferric chloride, phosphoric acid, oxalic acid and urea in deionized water and mix them well to form a mixed solution;
b. pour the mixed solution into a stainless steel reactor and then completely seal the reactor, and set the reaction temperature at 100° C., the reaction time at 24 h and the reactor heating rate at 2° C./min; and
c. open the reactor when the temperature drops to room temperature after the reaction is over, filter the solution with filter paper and then wash with deionized water 3 times to obtain a product.

8. Preparation of the metal-organic framework material fertilizer according to claim 3, wherein there are the following steps,
a. completely dissolve ferric chloride, zinc sulfate, phosphoric acid, oxalic acid and urea in deionized water and mix them well to form a mixed solution;
b. pour the mixed solution into a stainless steel reactor and then completely seal the reactor, and set the reaction temperature at 100° C., the reaction time at 24 h and the reactor heating rate at 2° C./min; and
c. open the reactor when the temperature drops to room temperature after the reaction is over, filter the solution with filter paper and then wash with deionized water 3 times to obtain a product.
